(19) United States
(12) Patent Application Publication
(10) Pub. No.: US 2025/0272999 A1
(43) Pub. Date: Aug. 28, 2025

(54) VIDEO TITLE GENERATION METHOD, APPARATUS, ELECTRONIC DEVICE, AND STORAGE MEDIUM

(71) Applicant: DOUYIN VISION CO., LTD., Beijing (CN)

(72) Inventors: Junjun ZOU, Beijing (CN); Zhiguang Wang, Beijing (CN); Lingmin Lin, Beijing (CN)

(21) Appl. No.: 19/058,315

(22) Filed: Feb. 20, 2025

(30) Foreign Application Priority Data
Feb. 26, 2024 (CN) 202410211764.9

(51) Int. Cl. G06V 20/70; G06V 10/82; G06V 20/40

(52) U.S. Cl. CPC G06V 20/70; G06V 10/82; G06V 20/41; G06V 20/46

(57) ABSTRACT

The present disclosure relates to the field of multi-modality content processing, and a video title generation method and apparatus, an electronic device, and a storage medium are disclosed. The method includes: obtaining a target video to be processed; extracting a target description content corresponding to the target video; and identifying, using a title generation model, a language feature and a scene feature of the target description content, and generating a target video title of the target video based on the language feature and the scene feature.

### CROSS-REFERENCE TO RELATED APPLICATION

This application claims priority to Chinese Application No. 202410211764.9 filed on Feb. 26, 2024, the disclosure of which is incorporated herein by reference in its entirety.

### FIELD

The present disclosure relates to the field of multi-modality content processing, and in particular, to a video title generation method, an apparatus, an electronic device, and a storage medium.

### BACKGROUND

With the popularity of social media and information videos, people have an increasing demand for quickly understanding the content of a video. Due to the limitation on the number of words in a title, it is impossible to provide sufficient information. Therefore, a supplementary title sentence summarizing the content of a video may be generated to provide more key information and appealing content.

At present, a general large language model has powerful text generation capabilities and can generate relevant title sentences according to video content. By training on a large-scale general corpus, the model learns rich language knowledge and semantic understanding capabilities, can deduce relevant background information from the content, and generates concise title sentences.

### SUMMARY

In view of this, the embodiments of the present disclosure provide a video title generation method, an apparatus, an electronic device, and a storage medium.

In a first aspect, the embodiments of the present disclosure provide a video title generation method, including:
obtaining a target video to be processed;
extracting a target description content corresponding to the target video; and
identifying, using a title generation model, a language feature and a scene feature of the target description content, and generating a target video title of the target video based on the language feature and the scene feature, where the title generation model includes a first sub-model and a second sub-model, the first sub-model is a trained language model, the second sub-model is a neural network model corresponding to a video type corresponding to the target video, the first sub-model is configured to identify the language feature, and the second sub-model is configured to identify the scene feature.

In a second aspect, the embodiments of the present disclosure provide a video title generation apparatus, including:
an obtaining module, configured to obtain a target video to be processed;
an extraction module, configured to extract a target description content corresponding to the target video; and
an identification module, configured to identify, using a title generation model, a language feature and a scene feature of the target description content, and generate a target video title of the target video based on the language feature and the scene feature, where the title generation model includes a first sub-model and a second sub-model, the first sub-model is a trained language model, the second sub-model is a neural network model corresponding to a video type corresponding to the target video, the first sub-model is configured to identify the language feature, and the second sub-model is configured to identify the scene feature.

In a third aspect, the embodiments of the present disclosure provide an electronic device, including: a memory and a processor, where the memory and the processor are communicatively connected with each other, computer instructions are stored in the memory, and the processor executes the computer instructions, to perform the method according to the first aspect or any implementation of the first aspect.

In a fourth aspect, the embodiments of the present disclosure provide a computer-readable storage medium, storing computer instructions thereon, where the computer instructions are used to cause a computer to perform the method according to the first aspect or any implementation of the first aspect.

### BRIEF DESCRIPTION OF THE DRAWINGS

In order to more clearly illustrate the technical solutions in the specific implementations of the present disclosure or in the prior art, the following will briefly introduce the drawings that need to be used in the description of the specific implementations or the prior art. Obviously, the drawings in the following description are some implementations of the present disclosure, and for those of ordinary skill in the art, other drawings can be obtained based on these drawings without creative efforts.

FIG. 1 is a flowchart of a video title generation method according to some embodiments of the present disclosure;

FIG. 2 is a flowchart of a video title generation method according to some embodiments of the present disclosure;

FIG. 3 is a schematic diagram of a title generation model according to some embodiments of the present disclosure;

FIG. 4 is a schematic diagram of a video title generation process according to some embodiments of the present disclosure;

FIG. 5 is a flowchart of a video title generation method according to some embodiments of the present disclosure;

FIG. 6 is a block diagram of a video title generation apparatus according to an embodiment of the present disclosure; and

FIG. 7 is a schematic diagram of a hardware structure of an electronic device according to an embodiment of the present disclosure.

### DETAILED DESCRIPTION OF EMBODIMENTS

In order to make the objectives, technical solutions and advantages of the embodiments of the present disclosure clearer, the technical solutions in the embodiments of the present disclosure will be described clearly and comprehensively with reference to the drawings in the embodiments of the present disclosure. Obviously, the described embodiments are part of the embodiments of the present disclosure, rather than all embodiments. Based on the embodiments in the present disclosure, all other embodiments obtained by those skilled in the art without creative efforts fall within the protection scope of the present disclosure.

However, at present, the general large language model cannot create an appropriate title sentence according to the video content, because the video content in a specific field is not trained during the training process. Moreover, the title generated by the general large language model may be semantically reasonable, but does not completely match the video content.

According to the method of the present application, by identifying the language feature and the scene feature of the target description content, the theme, content, and field of a video can be better understood, so that a more accurate title can be generated. Compared with the solution in which a general large language model generates a video title, the video title generated by the present application can better match video content. In addition, generating the target video title of the target video based on the language feature and the scene feature can better and comprehensively summarize the key information and highlights of the video, thereby improving the correlation between the title and video content.

According to the embodiments of the present disclosure, a video title generation method and apparatus, an electronic device, and a storage medium are provided. It should be noted that the steps shown in the flowcharts in the drawings may be executed in a computer system such as a set of computer-executable instructions, and although a logical order is shown in the flowcharts, in some cases, the steps shown or described may be executed in an order different from the order herein.

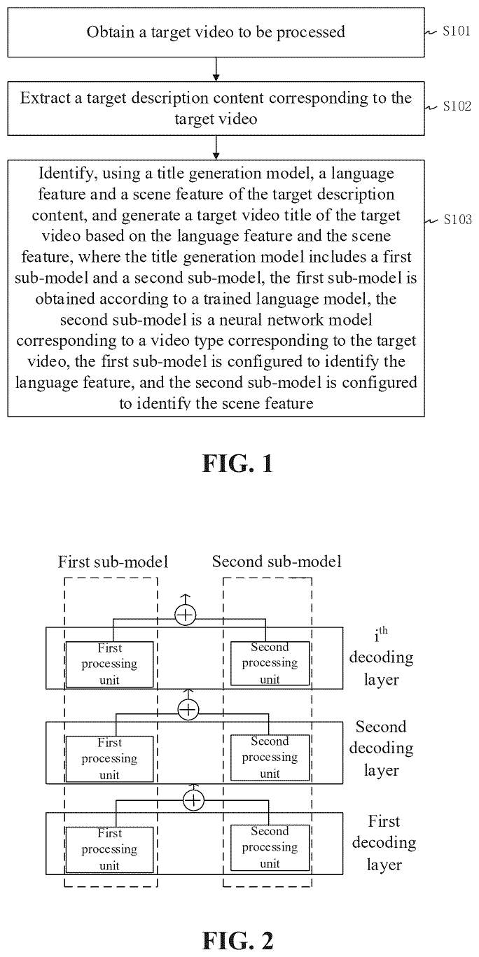

In this embodiment, a video title generation method is provided. FIG. 1 is a flowchart of a video title generation method according to an embodiment of the present disclosure. As shown in FIG. 1, the process includes the following steps.

In a first aspect, an embodiment of the present disclosure provides a video title generation method, including the following steps.

Step S101: obtain a target video to be processed.

In the embodiments of the present application, the target video is obtained from an available data source. The data source may include an online video platform, a database, etc. The target video may relate to multiple video fields, such as sports, economy, cooking, and technology. Specifically, various online video platforms may be accessed, and videos in a related field may be found by searching for a search keyword or browsing a video category in the related field. Alternatively, a video data set related to a field may be searched for. The data set may contain videos in a specific field. Alternatively, videos related to a field may be collected or recorded according to a demand.

Step S102: extract a target description content corresponding to the target video.

In the embodiments of the present application, the obtained target video is preprocessed firstly, which may include video format conversion, video segmentation, frame extraction, etc. Then, description extraction is performed on the preprocessed target video, for example, using a method such as speech recognition or natural language processing. Specifically, a speech recognition technology may be used to convert audio in the video into text content, or a video content analysis technology may be used to extract key content from the video. Then, data cleaning and sorting are performed on the extracted content to remove unnecessary punctuation, special characters, or non-sense content, and text preprocessing is performed to obtain the target description content, such as case conversion and stop word removal.

Step S103: identify, using a title generation model, a language feature and a scene feature of the target description content, and generate a target video title of the target video based on the language feature and the scene feature. The title generation model includes a first sub-model and a second sub-model. The first sub-model is a trained language model. The second sub-model is a neural network model corresponding to a video type corresponding to the target video. The first sub-model is configured to identify the language feature, and the second sub-model is configured to identify the scene feature.

In the embodiments of the present application, the title generation model includes at least one decoding layer hierarchically arranged, and each decoding layer includes: a first processing unit in the first sub-model and a second processing unit in the second sub-model. The process of constructing the title generation model is as follows:

Firstly, a pre-trained language model is obtained, and the language model is used as the first sub-model. Specifically, the language model may be a general large language model, which is obtained by training on a large-scale corpus and capable of capturing rich semantics and language rules. These models are usually based on deep learning technologies, such as BERT and GPT. An open-source language model, such as a pre-trained model provided in a Transformers library of Hugging Face, may be used. By using the pre-trained general large language model as the first sub-model, rich language features may be obtained to help generate a more accurate and attractive target video title.

Secondly, the video type corresponding to the target video is obtained. Specifically, a video content analysis technology, such as image processing, object recognition, and action recognition, is used to analyze the content in the video. The type to which the video belongs may be determined according to the features, such as an object, a person, a scene, and an action, that appear in the video. For example, if a football field, a football player, and a game action appear in the video, it can be determined that the video belongs to a sport type. If the video is attached with label or metadata information during uploading or publishing, the type of the video may be determined through the information. These labels may be provided by an uploader or generated through an automatic labeling or semi-automatic labeling technology. For example, if the labels contain keywords such as “music” and “speech”, it can be determined that the video type is music or speech.

Then, a neural network model corresponding to the video type is used as the second sub-model. Specifically, neural network models corresponding to a plurality of video types are pre-trained, for example, neural network models in different fields such as sports, movies, music, and news may be trained. Then, a neural network model corresponding to the video type of the target video is determined from the neural network models corresponding to the plurality of video types, and the neural network model is used as the second sub-model.

Finally, the first sub-model is connected with the second sub-model to obtain the title generation model. Specifically, as shown in FIG. 2, the first sub-model includes a plurality of first processing units, and the second sub-model includes a plurality of second processing units. Each first processing unit is connected with each second processing unit to construct the decoding layer.

It can be understood that the first sub-model may be a general large language model, and the general large language model may understand and generate a natural language. In video title generation, the general large language model is used to generate an initial title candidate. They have powerful language understanding and generation capabilities and achieve good performance in a wide range of language tasks. The general large language model may generate multiple possible titles according to given video description content, but may lack expertise in specific tasks and fields.

The second sub-model may be understood as a customized model for a field, and the customized model is a model that is trained according to a specific task and a dataset. In video title generation, the customized model is used to screen and improve a candidate title generated by the general large language model. The customized model may assess and adjust the title according to a specific standard and requirement, to generate a title that better meets an expectation. It may improve the accuracy and expertise of a video title generation task through training on a specific dataset and task.

Therefore, by using the general large language model in combination with the customized model, the language generation capability of the general model can be fully utilized and then refined and optimized through the customized model, thereby generating a title that better complies with video content. This combination can improve the correlation and quality of the generated title while maintaining the language generation capability.

Based on this, in the embodiments of the present application, the general large language model is used to identify the target description content to obtain the language feature, and the language feature includes a keyword, an action description, a target feature, etc. The keyword may be a noun, a verb, an adjective, etc. related to the target. The action description may be understood as an action or behavior of the target. The target feature may be an appearance, a feature, or a property of the target. At the same time, a customized model related to the video type of the target video may be used to identify the scene feature of the target description content. For example, the scene feature is a scene feature related to the field of sports, a scene feature related to the field of economy, or a scene feature related to the field of science and technology. The scene feature related to the field of sports includes a sports type, a team, a player, etc. The scene feature related to the field of economy includes economic data, a market trend, a financial institution, etc. The scene feature related to the field of science and technology includes a new scientific and technological product, an innovative technology, a scientific principle, etc. Finally, the obtained language feature and scene feature are fused to obtain the target video title of the target video. For example, the language feature includes “passion”, “competition”, “spectacular”, “contest”, and “ignite”. The scene feature is a football field. The fused target video title is “spectacular contest ignites the football field”.

According to the method provided in the embodiments of the present application, by identifying the language feature and the scene feature of the target description content, the theme, content, and field of a video can be better understood, so that a more accurate title can be generated. Compared with the solution in which a general large language model generates a video title, the video title generated by the present application can better match video content. In addition, generating the target video title of the target video based on the language feature and the scene feature can better and comprehensively summarize the key information and highlights of the video, thereby improving the correlation between the title and video content.

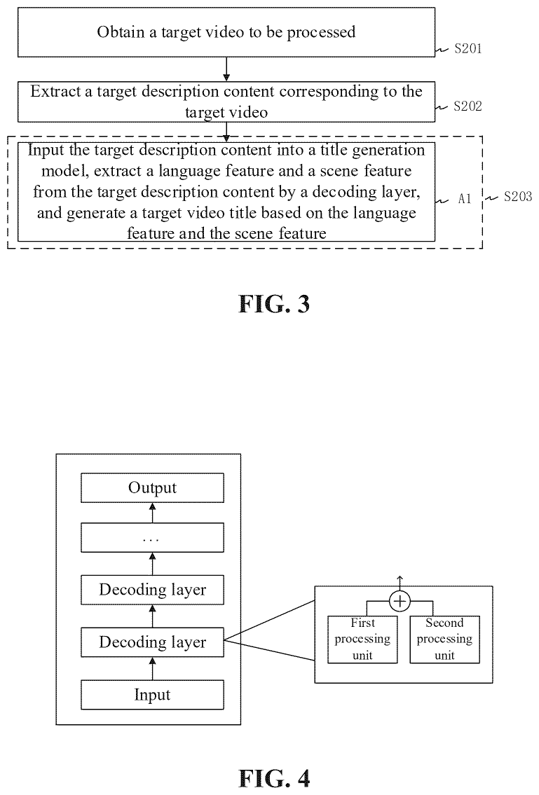

FIG. 3 is a flowchart of a video title generation method according to an embodiment of the present disclosure. As shown in FIG. 3, the process includes the following steps.

Step S201: obtain a target video to be processed. For detailed description, reference may be made to the related description corresponding to the above embodiments, and details are not described herein again.

Step S202: extract a target description content corresponding to the target video. For detailed description, reference may be made to the related description in the above embodiments, and details are not described herein again.

Step S203: identify, using a title generation model, a language feature and a scene feature of the target description content, and generate a target video title of the target video based on the language feature and the scene feature. The title generation model includes a first sub-model and a second sub-model. The first sub-model is a trained language model. The second sub-model is a neural network model corresponding to a video type corresponding to the target video. The first sub-model is configured to identify the language feature, and the second sub-model is configured to identify the scene feature.

In the embodiments of the present application, identifying, using the title generation model, the language feature and the scene feature of the target description content, and generating the target video title of the target video based on the language feature and the scene feature includes the following step.

Step A1: input the target description content into the title generation model, extract the language feature and the scene feature from the target description content by the decoding layer, and generate the target video title based on the language feature and the scene feature.

In the embodiments of the present application, extracting the language feature and the scene feature from the target description content by the decoding layer, and generating the target video title based on the language feature and the scene feature includes the following steps a201 to a204.

Step a201: extract a first language feature from the target description content by a first processing unit in a first decoding layer, and extract a first scene feature from the target description content by a second processing unit in the first decoding layer.

Step a202: fuse the first language feature and the first scene feature to obtain a first fusion result, and pass the first fusion result to a second decoding layer, where the second decoding layer is a next decoding layer of the first decoding layer.

Step a203: extract a second language feature from the first fusion result by a first processing unit in the second decoding layer, and extract a second scene feature from the first fusion result by a second processing unit in the second decoding layer.

Step a204: fuse the second language feature and the second scene feature to obtain a second fusion result, and pass the second fusion result to a next decoding layer of the second decoding layer, until the target video title output by the last decoding layer in the title generation model is obtained.

In the embodiments of the present application, as shown in FIG. 4, the first processing unit in the first decoding layer extracts the first language feature from the target description content. This may be achieved by using a natural language processing technology, such as word embedding, a recurrent neural network (RNN), or a convolutional neural network (CNN). The processing unit may extract a language feature, such as a keyword, from the target description content. The second processing unit in the first decoding layer extracts the first scene feature from the target description content. This may be extracted by using a field-exclusive customized model. The first scene feature includes field-related knowledge, a related word, etc.

Then, the first language feature and the first scene feature are fused to obtain the first fusion result. This may be achieved by performing concatenation, weighted summation or attention mechanism, etc. on the language feature and the scene feature. The fusion result will include comprehensive information of the first language feature and the first scene feature. The first fusion result is passed to the second decoding layer.

The second decoding layer is the next decoding layer of the first decoding layer. In this way, the first fusion result may be used as input, to continue to further extract a higher-level language feature and scene feature. The first processing unit in the second decoding layer extracts the second language feature from the first fusion result. This may be achieved by using a similar natural language processing technology, such as RNN or CNN, to further extract a more abstract language feature. The second processing unit in the second decoding layer extracts the second scene feature from the first fusion result. The first scene feature includes field-related knowledge, a related word, etc.

The second language feature and the second scene feature are fused to obtain the second fusion result. Similarly, the two features may be fused by using the methods such as concatenation, weighted summation, and attention mechanism, to obtain a comprehensive language feature and scene feature. The second fusion result is passed to the next decoding layer of the title generation model. In this way, higher-level features can be gradually extracted and the final target video title can be generated.

Through the above process, the language feature and the scene feature are extracted from the target description content and fused by using different decoding layers, and the output of the last decoding layer in the title generation model, that is, the title of the target video, is finally obtained. This hierarchical and multi-step processing can better capture and express the key information of the video, and improve the accuracy and quality of the generated title.

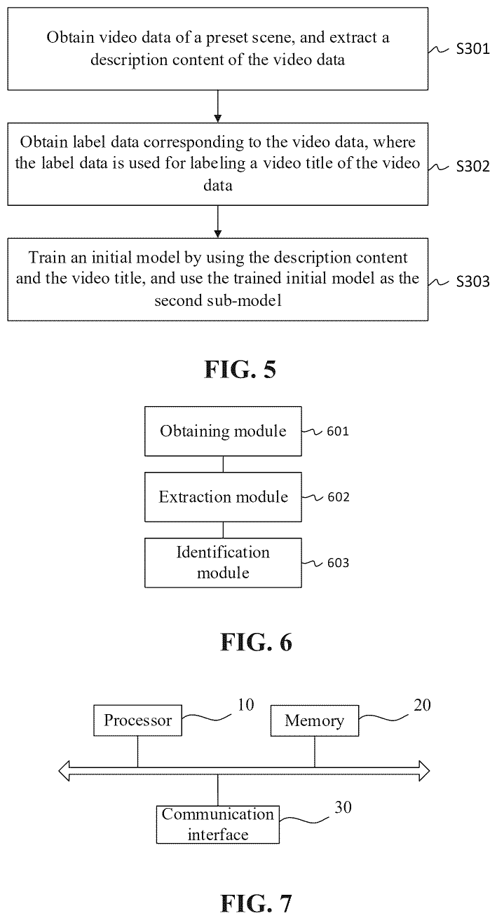

In the embodiments of the present application, as shown in FIG. 5, the method further includes the following steps S301 to S303.

Step S301: obtain video data of a preset scene, and extract a description content of the video data.

Specifically, video data related to the preset scene is collected. This may include downloading or recording a related video clip from a public video sharing platform, a research database, a television program, or other sources. Then, preprocessing is performed on the obtained video, where the preprocessing includes video format conversion, video segmentation, frame extraction, etc. Description extraction is performed on the preprocessed target video, for example, using a method such as speech recognition or natural language processing. Specifically, a speech recognition technology may be used to convert audio in the video into text content, or a video content analysis technology may be used to extract key content from the video. Data cleaning and sorting are performed on the extracted content to remove unnecessary punctuation, special characters, or non-sense content, and text preprocessing is performed to obtain the description content, such as case conversion and stop word removal.

Step S302: obtain label data corresponding to the video data, where the label data is used for labeling a video title of the video data.

Specifically, the video data and the corresponding label data are collected. The label data may be manually created, obtained from a labeled dataset, or labeled through a third-party platform. If there is already labeled data, it may be directly used. If there is no labeled data, manual labeling is required. For each video data, an appropriate title is assigned to it by watching the video and understanding the video content. The title may be associated with the file name, the file path, or other unique identifier of the video data.

The label data may be obtained by: obtaining a weight of each video data corresponding to the preset scene; performing weighted concatenation on description content of each video data based on the weight of the video data, to obtain the video title corresponding to the video data; and using the video title as the label data.

For example, assuming that there are three pieces of associated video data in the preset scene, which are video data A, video data B, and video data C, with weights of 0.4, 0.3, and 0.3, respectively, and corresponding description contents of descriptionA, descriptionB, and descriptionC, weighted concatenation may be performed according to the weights, that is, 0.4×descriptionA+0.3×descriptionB+0.3×descriptionC is concatenated to obtain a common title for multiple related videos. By means of weighted concatenation, the description contents may be weighted according to the importance or weight of the video, so that the generated title can more accurately reflect the theme or key information of the multiple related videos. The title generated in this way can provide a better information reference by more comprehensively describing the content of the multiple related videos.

Step S303: train an initial model by using the description content and the video title, and use the trained initial model as the second sub-model.

Specifically, training the initial model by using the description content and the video title, and using the trained initial model as the second sub-model includes the following steps b1 to b4.

Step b1: construct a word sequence based on the description content.

Specifically, firstly, the description content is tokenized, and the description content is tokenized into a single word or individual words. A word tokenization tool, a natural language processing library, or a pre-trained model may be used to complete the word tokenization operation. The words obtained through word tokenization are grouped into a word sequence in order. A list or an array data structure may be used to store these words, and their order relationship is retained.

Step b2: input the word sequence into the initial model, output, by the initial model, a predicted word according to the word sequence, and determine a probability distribution corresponding to the predicted word.

Specifically, the word sequence is provided to the initial model, and an inference process is performed. The initial model may generate a predicted word as output, and the predicted word represents the most likely next word given the word sequence. By calculating the output predicted word, the probability distribution corresponding to the predicted word may be obtained. The probability distribution corresponding to the predicted word may be obtained by calculating the output of the model. Generally, the model may generate a probability distribution with a vocabulary size, where the probability of each word represents that the word is the next most likely word given the input. A statistical method (such as a softmax function) may be used to convert the output of the model into a probability distribution.

Step b3: calculate a training loss of the initial model by using the probability distribution.

Specifically, calculating the training loss of the initial model by using the probability distribution includes: extracting, from the video title, a real word corresponding to the predicted word, and creating a one-hot encoding vector corresponding to the real word; and calculating the training loss based on the one-hot encoding vector and the probability distribution corresponding to the predicted word.

Assuming that there is a video title “delicious pasta recipe”, and the next word predicted by the initial model is “recipe”, the real next word, that is, “recipe”, is extracted from the title. According to the real word in the title, it may be converted into a one-hot encoding vector. One-hot encoding is a method for representing a categorical variable, and only one element in the vector is 1, while the remaining elements are 0. For example, assuming that the vocabulary size is 10,000, a vector with a length of 10,000 may be created, where the element whose subscript corresponds to the recipe is 1, and the remaining elements are 0. The loss function is calculated based on the created one-hot encoding vector and the probability distribution corresponding to the predicted word. A commonly used loss function is a cross entropy loss function, which is used to compare the difference between the predicted probability distribution and the real one-hot encoding vector. The loss function is used to represent the difference between the predicted distribution and the real distribution.

By calculating the training loss, the prediction performance and accuracy of the model for the current predicted word may be obtained. Through a backpropagation algorithm and an optimizer, the parameter of the model may be updated to minimize the training loss, so as to improve the performance and accuracy of the model.

Step b4: update the model parameter of the initial model by using the training loss, until the updated initial model satisfies a training condition, and use the initial model satisfying the training condition as the second sub-model.

Specifically, an optimization algorithm (such as gradient descent, Adam, etc.) is used to update the model parameter according to gradient information. The objective of the parameter update is to minimize the training loss. After each parameter update, whether the initial model satisfies the training condition is checked. The training condition may be a specified number of training rounds, a certain accuracy rate, a loss threshold, etc. If the initial model does not satisfy the training condition, the training continues. When the initial model satisfies the training condition, that is, when a specified number of training rounds or an accuracy threshold is reached, the initial model may be regarded as the second sub-model.

In the present application, the semantic information of the description content may be effectively represented through the word sequence, and the model is used to predict the given word sequence, to obtain the next most likely word. This helps to generate a title content that conforms to semantics. By calculating the training loss, the accuracy of the model in generating the predicted word can be learned. Through the backpropagation of the training loss and the parameter update, the performance of the model can be gradually optimized, so that the model can better match the given description content. After a plurality of rounds of training, an initial model that satisfies the training condition may be obtained.

In this embodiment, a video title generation apparatus is further provided. The apparatus is used to implement the above embodiments and preferred implementations, and the description of which has been made is not repeated. As used below, the term “module” may implement a combination of software and/or hardware with predetermined functions. Although the apparatus described in the following embodiments is preferably implemented in software, the implementation of hardware, or a combination of software and hardware is also possible and conceived.

This embodiment provides a video title generation apparatus, as shown in FIG. 6, including:
an obtaining module 601, configured to obtain a target video to be processed;
an extraction module 602, configured to extract a target description content corresponding to the target video; and
an identification module 603, configured to identify, using a title generation model, a language feature and a scene feature of the target description content, and generate a target video title of the target video based on the language feature and the scene feature. The title generation model includes a first sub-model and a second sub-model. The first sub-model is a trained language model. The second sub-model is a neural network model corresponding to a video type corresponding to the target video. The first sub-model is configured to identify the language feature, and the second sub-model is configured to identify the scene feature.

In some optional implementations, the identification module 603 includes:
a generation unit, configured to input the target description content into the title generation model, extract the language feature and the scene feature from the target description content by the decoding layer, and generate the target video title based on the language feature and the scene feature.

In some optional implementations, the generation unit is configured to extract a first language feature from the target description content by a first processing unit in a first decoding layer, and extract a first scene feature from the target description content by a second processing unit in the first decoding layer; fuse the first language feature and the first scene feature to obtain a first fusion result, and pass the first fusion result to a second decoding layer, where the second decoding layer is a next decoding layer of the first decoding layer; extract a second language feature from the first fusion result by a first processing unit in the second decoding layer, and extract a second scene feature from the first fusion result by a second processing unit in the second decoding layer; and fuse the second language feature and the second scene feature to obtain a second fusion result, and pass the second fusion result to a next decoding layer of the second decoding layer, until the target video title output by the last decoding layer in the title generation model is obtained.

In some optional implementations, the apparatus further includes a training module, and the training module includes:
a first obtaining unit, configured to obtain video data of a preset scene, and extract a description content of the video data;
a second obtaining unit, configured to obtain label data corresponding to the video data, where the label data is used for labeling a video title of the video data; and
a processing unit, configured to train an initial model by using the description content and the video title, and use the trained initial model as the second sub-model.

In some optional implementations, the processing unit is configured to: construct a word sequence based on the description content; input the word sequence into the initial model, output, by the initial model, a predicted word according to the word sequence, and determine a probability distribution corresponding to the predicted word; calculate a training loss of the initial model by using the probability distribution; and update a model parameter of the initial model by using the training loss, until the updated initial model satisfies a training condition, and use the initial model satisfying the training condition as the second sub-model.

In some optional implementations, the processing unit is configured to: extract, from the video title, a real word corresponding to the predicted word, and create a one-hot encoding vector corresponding to the real word; and calculate the training loss based on the one-hot encoding vector and the probability distribution corresponding to the predicted word.

In some optional implementations, the second obtaining unit is configured to: obtain a weight of each video data corresponding to the preset scene; perform weighted concatenation on description content of each video data based on the weight of the video data, to obtain the video title corresponding to the video data; and use the video title as the label data.

Please refer to FIG. 7, which is a schematic structural diagram of an electronic device according to an optional embodiment of the present disclosure. As shown in FIG. 7, the electronic device includes: one or more processors 10, a memory 20, and interfaces for connecting components, including a high-speed interface and a low-speed interface. The components are communicatively connected with each other through different buses and may be installed on a common main board or in other manners according to requirements. The processor may process instructions executed within the electronic device, including instructions stored in or on the memory to display graphical information of a GUI on an external input/output apparatus (such as a display device coupled to the interface). In some optional implementations, multiple processors and/or multiple buses may be used in conjunction with multiple memories and multiple memories if required. Similarly, multiple electronic devices may be connected, and each device provides part of necessary operations (for example, as a server array, a group of blade servers, or a multi-processor system).

The processor 10 may be a central processing unit, a network processor, or a combination thereof. The processor 10 may further include a hardware chip. The hardware chip may be an application-specific integrated circuit, a programmable logic device, or a combination thereof. The programmable logic device may be a complex programmable logic device, a field programmable logic gate array, a general array logic, or any combination thereof.

The memory 20 stores instructions executable by at least one processor 10, so that the at least one processor 10 executes the method shown in the above embodiments.

The memory 20 may include a program storage area and a data storage area, where the program storage area may store an operating system and an application required for at least one function; and the data storage area may store data created according to the use of an electronic device for displaying an applet landing page, etc. In addition, the memory 20 may include a high-speed random-access memory, and may also include a non-transitory memory, such as at least one magnetic disk storage device, a flash memory device, or other non-transitory solid-state storage device. In some optional implementations, the memory 20 optionally includes a memory provided remotely from the processor 10, and the remote memory may be connected to the electronic device through a network. Examples of the network include but are not limited to the Internet, an intranet, a local area network, a mobile communication network, and combinations thereof.

The memory 20 may include a volatile memory, for example, a random-access memory. The memory may also include a non-volatile memory, for example, a flash memory, a hard disk, or a solid-state disk. The memory 20 may further include a combination of the above types of memories.

The electronic device further includes a communication interface 30 configured to communicate with other devices or communication networks.

The embodiments of the present disclosure further provide a computer-readable storage medium. The method according to the embodiments of the present disclosure may be implemented in hardware or firmware, or as computer codes that may be recorded in a storage medium, or as computer codes that are originally stored in a remote storage medium or a non-transitory machine-readable storage medium and downloaded through a network and will be stored in a local storage medium, so that the method described herein may be processed by software storing on a storage medium using a general-purpose computer, a dedicated processor, or programmable or dedicated hardware. The storage medium may be a magnetic disk, an optical disc, a read-only memory, a random-access memory, a flash memory, a hard disk, a solid-state disk, or the like. Further, the storage medium may further include a combination of the above types of memories. It can be understood that a computer, a processor, a microprocessor, a controller, or programmable hardware includes a storage component that can store or receive software or computer codes, and when the software or computer codes are accessed and executed by the computer, the processor, or the hardware, the method shown in the above embodiments is implemented.

Although the embodiments of the present disclosure are described in combination with the drawings, those skilled in the art can make various modifications and variations without departing from the spirit and scope of the present disclosure, and such modifications and variations all fall within the scope defined by the appended claims.

I/We claim:

1. A video title generation method, comprising:
obtaining a target video to be processed;
extracting a target description content corresponding to the target video; and
identifying, using a title generation model, a language feature and a scene feature of the target description content, and generating a target video title of the target video based on the language feature and the scene feature, wherein the title generation model comprises a first sub-model and a second sub-model, the first sub-model is a trained language model, the second sub-model is a neural network model corresponding to a video type corresponding to the target video, the first sub-model is configured to identify the language feature, and the second sub-model is configured to identify the scene feature.

2. The method of claim 1, wherein the title generation model comprises at least one decoding layer hierarchically arranged, and each of the decoding layers comprises: a first processing unit in the first sub-model and a second processing unit in the second sub-model; and
identifying, using the title generation model, the language feature and the scene feature of the target description content, and generating the target video title of the target video based on the language feature and the scene feature comprises:
inputting the target description content into the title generation model, extracting the language feature and the scene feature from the target description content by the decoding layer, and generating the target video title based on the language feature and the scene feature.

3. The method of claim 2, wherein extracting the language feature and the scene feature from the target description content by the decoding layer, and generating the target video title based on the language feature and the scene feature comprises:
extracting a first language feature from the target description content by a first processing unit in a first decoding layer, and extracting a first scene feature from the target description content by a second processing unit in the first decoding layer;
fusing the first language feature and the first scene feature to obtain a first fusion result, and passing the first fusion result to a second decoding layer, wherein the second decoding layer is a next decoding layer of the first decoding layer;
extracting a second language feature from the first fusion result by a first processing unit in the second decoding layer, and extracting a second scene feature from the first fusion result by a second processing unit in the second decoding layer; and
fusing the second language feature and the second scene feature to obtain a second fusion result, and passing the second fusion result to a next decoding layer of the second decoding layer, until the target video title output by a last decoding layer in the title generation model is obtained.

4. The method of claim 2, further comprising:
obtaining video data of a preset scene, and extracting a description content of the video data;
obtaining label data corresponding to the video data, wherein the label data is used for labeling a video title of the video data; and
training an initial model by using the description content and the video title, and using the trained initial model as the second sub-model.

5. The method of claim 4, wherein training the initial model by using the description content and the video title, and using the trained initial model as the second sub-model comprises:
constructing a word sequence based on the description content;
inputting the word sequence into the initial model, outputting, by the initial model, a predicted word according to the word sequence, and determining a probability distribution corresponding to the predicted word;
calculating a training loss of the initial model by using the probability distribution; and
updating a model parameter of the initial model by using the training loss, until the updated initial model satisfies a training condition, and using the initial model satisfying the training condition as the second sub-model.

6. The method of claim 5, wherein calculating the training loss of the initial model by using the probability distribution comprises:
extracting, from the video title, a real word corresponding to the predicted word, and creating a one-hot encoding vector corresponding to the real word; and
calculating the training loss based on the one-hot encoding vector and the probability distribution corresponding to the predicted word.

7. The method of claim 4, wherein obtaining the label data corresponding to the video data comprises:
obtaining a weight of each video data corresponding to the preset scene;
performing weighted concatenation on description contents of each video data based on the weight of the video data, to obtain the video title corresponding to the video data; and
using the video title as the label data.

8. An electronic device, comprising:
a memory and a processor, wherein the memory and the processor are communicatively connected with each other, computer instructions are stored in the memory, and the computer instructions, when executed by the processor, cause the processor to:
obtain a target video to be processed;
extract a target description content corresponding to the target video; and
identify, using a title generation model, a language feature and a scene feature of the target description content, and generate a target video title of the target video based on the language feature and the scene feature, wherein the title generation model comprises a first sub-model and a second sub-model, the first sub-model is a trained language model, the second sub-model is a neural network model corresponding to a video type corresponding to the target video, the first sub-model is configured to identify the language feature, and the second sub-model is configured to identify the scene feature.

9. The electronic device of claim 8, wherein the title generation model comprises at least one decoding layer hierarchically arranged, and each of the decoding layers comprises: a first processing unit in the first sub-model and a second processing unit in the second sub-model; and
the computer instructions for identifying, using the title generation model, the language feature and the scene feature of the target description content, and generating the target video title of the target video based on the language feature and the scene feature, further cause the processor to:
input the target description content into the title generation model, extract the language feature and the scene feature from the target description content by the decoding layer, and generate the target video title based on the language feature and the scene feature.

10. The electronic device of claim 9, wherein the computer instructions for extracting the language feature and the scene feature from the target description content by the decoding layer, and generating the target video title based on the language feature and the scene feature, further cause the processor to:
extract a first language feature from the target description content by a first processing unit in a first decoding layer, and extract a first scene feature from the target description content by a second processing unit in the first decoding layer;
fuse the first language feature and the first scene feature to obtain a first fusion result, and pass the first fusion result to a second decoding layer, wherein the second decoding layer is a next decoding layer of the first decoding layer;
extract a second language feature from the first fusion result by a first processing unit in the second decoding layer, and extract a second scene feature from the first fusion result by a second processing unit in the second decoding layer; and
fuse the second language feature and the second scene feature to obtain a second fusion result, and pass the second fusion result to a next decoding layer of the second decoding layer, until the target video title output by a last decoding layer in the title generation model is obtained.

11. The electronic device of claim 9, wherein the computer instructions further cause the processor to:
obtain video data of a preset scene, and extracting a description content of the video data;
obtain label data corresponding to the video data, wherein the label data is used for labeling a video title of the video data; and
train an initial model by using the description content and the video title, and use the trained initial model as the second sub-model.

12. The electronic device of claim 11, wherein the computer instructions for training the initial model by using the description content and the video title, and using the trained initial model as the second sub-model, further cause the processor to:
construct a word sequence based on the description content;
input the word sequence into the initial model, output, by the initial model, a predicted word according to the word sequence, and determine a probability distribution corresponding to the predicted word;
calculate a training loss of the initial model by using the probability distribution; and
update a model parameter of the initial model by using the training loss, until the updated initial model satisfies a training condition, and use the initial model satisfying the training condition as the second sub-model.

13. The electronic device of claim 12, wherein the computer instructions for calculating the training loss of the initial model by using the probability distribution, further cause the processor to:
extract, from the video title, a real word corresponding to the predicted word, and create a one-hot encoding vector corresponding to the real word; and
calculate the training loss based on the one-hot encoding vector and the probability distribution corresponding to the predicted word.

14. The electronic device of claim 11, wherein the computer instructions for obtaining the label data corresponding to the video data, further cause the processor to:
obtain a weight of each video data corresponding to the preset scene;
perform weighted concatenation on description contents of each video data based on the weight of the video data, to obtain the video title corresponding to the video data; and
use the video title as the label data.

15. A non-transitory computer-readable storage medium, storing computer instructions thereon, wherein the computer instructions are used to cause a computer to:
obtain a target video to be processed;
extract a target description content corresponding to the target video; and
identify, using a title generation model, a language feature and a scene feature of the target description content, and generate a target video title of the target video based on the language feature and the scene feature, wherein the title generation model comprises a first sub-model and a second sub-model, the first sub-model is a trained language model, the second sub-model is a neural network model corresponding to a video type corresponding to the target video, the first sub-model is configured to identify the language feature, and the second sub-model is configured to identify the scene feature.

16. The non-transitory computer-readable storage medium of claim 15, wherein the title generation model comprises at least one decoding layer hierarchically arranged, and each of the decoding layers comprises: a first processing unit in the first sub-model and a second processing unit in the second sub-model; and
the computer instructions for identifying, using the title generation model, the language feature and the scene feature of the target description content, and generating the target video title of the target video based on the language feature and the scene feature, further cause the computer to:
input the target description content into the title generation model, extract the language feature and the scene feature from the target description content by the decoding layer, and generate the target video title based on the language feature and the scene feature.

17. The non-transitory computer-readable storage medium of claim 16, wherein the computer instructions for extracting the language feature and the scene feature from the target description content by the decoding layer, and generating the target video title based on the language feature and the scene feature, further cause the computer to:
extract a first language feature from the target description content by a first processing unit in a first decoding layer, and extract a first scene feature from the target description content by a second processing unit in the first decoding layer;
fuse the first language feature and the first scene feature to obtain a first fusion result, and pass the first fusion result to a second decoding layer, wherein the second decoding layer is a next decoding layer of the first decoding layer;
extract a second language feature from the first fusion result by a first processing unit in the second decoding layer, and extract a second scene feature from the first fusion result by a second processing unit in the second decoding layer; and
fuse the second language feature and the second scene feature to obtain a second fusion result, and pass the second fusion result to a next decoding layer of the second decoding layer, until the target video title output by a last decoding layer in the title generation model is obtained.

18. The non-transitory computer-readable storage medium of claim 16, wherein the computer instructions further cause the computer to:
obtain video data of a preset scene, and extracting a description content of the video data;
obtain label data corresponding to the video data, wherein the label data is used for labeling a video title of the video data; and
train an initial model by using the description content and the video title, and use the trained initial model as the second sub-model.

19. The non-transitory computer-readable storage medium of claim 18, wherein the computer instructions for training the initial model by using the description content and the video title, and using the trained initial model as the second sub-model, further cause the computer to:
construct a word sequence based on the description content;
input the word sequence into the initial model, output, by the initial model, a predicted word according to the word sequence, and determine a probability distribution corresponding to the predicted word;
calculate a training loss of the initial model by using the probability distribution; and
update a model parameter of the initial model by using the training loss, until the updated initial model satisfies a training condition, and use the initial model satisfying the training condition as the second sub-model.

20. The non-transitory computer-readable storage medium of claim 19, wherein the computer instructions for calculating the training loss of the initial model by using the probability distribution, further cause the computer to:
extract, from the video title, a real word corresponding to the predicted word, and create a one-hot encoding vector corresponding to the real word; and
calculate the training loss based on the one-hot encoding vector and the probability distribution corresponding to the predicted word.
